(19) United States
(12) Patent Application Publication
(10) Pub. No.: US 2026/0183163 A1
(43) Pub. Date: Jul. 2, 2026

(54) Patient Transport Device for Traversing Uneven Terrain

(71) Applicants: Isaac Choi, Glenwood, MD (US); Joshua Choi, Glenwood, MD (US)

(72) Inventors: Isaac Choi, Glenwood, MD (US); Joshua Choi, Glenwood, MD (US)

(21) Appl. No.: 19/007,292

(22) Filed: Dec. 31, 2024

(51) Int. Cl. A61G 5/00; A61G 5/08; A61G 5/10; A61G 5/12

(52) U.S. Cl. CPC A61G 5/003; A61G 5/0875; A61G 5/1002; A61G 5/1078; A61G 5/1089; A61G 5/127; A61G 2220/20

(57) ABSTRACT

A transport device is disclosed. The transport device includes a frame assembly. A rear handle is coupled to a rear of the frame assembly. A pair of rear wheels are rotatably mounted on a rear axle connected to the frame assembly. A front wheel is rotatably mounted on a front axle connected to the frame assembly. A shock absorption assembly is coupled to the frame assembly and operatively associated with at least the pair of rear wheels and the front wheel. A bucket seat is mounted to the frame assembly. A pair of leg cradles are coupled to hold legs of the user in place and prevent interference with the front wheel and the pair of rear wheels during transport.

### BACKGROUND OF THE INVENTION

### Field of the Invention

This disclosure relates generally to transporting devices and more particularly to a transport device for traversing uneven terrain.

### Discussion of the State of the Art

Patient transport devices are essential for safely and efficiently transferring individuals with limited mobility in a variety of settings, such as hospitals, care facilities, and during emergency or outdoor rescue operations. Conventional patient transport devices, such as wheelchairs and stretchers, are designed primarily for use on smooth, even surfaces, such as hospital floors or paved pathways. These devices typically prioritize comfort, stability, and ease of flexibility under controlled conditions. However, in outdoor or emergency scenarios where the terrain may be uneven, steep, or rugged, such devices often fail to provide the necessary stability and functionality, compromising both patient safety and ease of transport. The challenges of rough terrain traversal, including handling impact forces, maintaining directional control, and preventing patient discomfort, necessitate the development of specialized transport solutions.

Existing patient transport devices are poorly equipped to handle traversal over uneven and challenging terrains. They often lack essential features such as shock absorption systems, stability mechanisms, or directional control capabilities tailored for rough terrain. Inadequate support for securing patients during transport can result in discomfort, injury, or interference with the movement of the transport device. Furthermore, the absence of multi-functional features, such as detachable or foldable components for compact storage and transport, limits the adaptability of such devices for emergency and outdoor applications.

Accordingly, there is a need for a transport device designed specifically to address the challenges of uneven terrain. Such a device should ensure patient safety, comfort, and stability while offering flexibility, ease of operation, and compatibility with varied environments.

### SUMMARY OF THE INVENTION

In an embodiment, a transport device is disclosed. The device may include a frame assembly. The device may further include a rear handle coupled to a rear of the frame assembly, for manually pushing or pulling the device. The device may further include a pair of rear wheels, rotatably mounted on a rear axle connected to the frame assembly. In an embodiment, the pair of rear wheels may be configured to provide stability and enable movement of the device over uneven terrain. The device may further include a front wheel rotatably mounted on a front axle connected to the frame assembly. In an embodiment, the front wheel provides directional control and facilitates traversal over steep and rough terrain. The device may further include a shock absorption assembly, coupled to the frame assembly and operatively associated with at least the pair of rear wheels and the front wheel, configured to reduce impact forces encountered on the rough terrain. The device may further include a bucket seat, mounted to the frame assembly, configured to securely hold a user in a seated position. The device may further include a pair of leg cradles, coupled to the frame assembly, configured to hold legs of the user in place and prevent interference with the front wheel and the pair of rear wheels during transport.

In another embodiment, a transport device is disclosed. The transport device may include a frame assembly. The transport device may further include rear handle coupled to a rear of the frame assembly, for manually pushing or pulling the transport device. The transport device may further include a pair of rear wheels, rotatably mounted on a rear axle connected to the frame assembly. In an embodiment, the pair of rear wheels may be configured to provide stability and enable movement of the transport device over uneven terrain. The transport device may further include a front wheel rotatably mounted on a front axle connected to the frame assembly. In an embodiment, the front wheel provides directional control and facilitates traversal over steep and rough terrain. The transport device may further include a shock absorption assembly, coupled to the frame assembly and operatively associated with at least the pair of rear wheels and the front wheel, configured to reduce impact forces encountered on the rough terrain. The transport device may further include a bucket seat, mounted to the frame assembly, configured to securely hold a user in a seated position. The transport device may further include a pair of leg cradles, coupled to the frame assembly, configured to hold legs of the user in place and prevent interference with the front wheel and the pair of rear wheels during transport. The transport device may further include a front handle, coupled to a front of the frame assembly and configured to enable pulling the transport device over steep inclines or rough terrain.

In yet another embodiment, a transport device is disclosed. The transport device may include a frame assembly. The transport device may further include rear handle coupled to a rear of the frame assembly, for manually pushing or pulling the transport device. The transport device may further include a pair of rear wheels, rotatably mounted on a rear axle connected to the frame assembly. In an embodiment, the pair of rear wheels may be configured to provide stability and enable movement of the transport device over uneven terrain. The transport device may further include a front wheel rotatably mounted on a front axle connected to the frame assembly. In an embodiment, the front wheel provides directional control and facilitates traversal over steep and rough terrain. The transport device may further include a shock absorption assembly, coupled to the frame assembly and operatively associated with at least the pair of rear wheels and the front wheel, configured to reduce impact forces encountered on the rough terrain. The transport device may further include a bucket seat, mounted to the frame assembly, configured to securely hold a user in a seated position. The transport device may further include a pair of leg cradles, coupled to the frame assembly, configured to hold legs of the user in place and prevent interference with the front wheel and the pair of rear wheels during transport. The transport device may further include a front hitch, coupled to the frame assembly and configured for attachment to a bicycle, enabling the transport device to be towed over varied terrains.

It is to be understood that both the foregoing general description and the following detailed descriptions are exemplary and explanatory only and are not restrictive of the invention, as claimed.

### BRIEF DESCRIPTION OF THE DRAWING FIGURES

The accompanying drawings, which are incorporated in and constitute a part of this disclosure, illustrate exemplary embodiments and, together with the description, serve to explain the disclosed principles.

FIG. 1A illustrates a perspective view of an exemplary transport device, in accordance with an embodiment of the present disclosure.

FIG. 1B illustrates a side view of the exemplary transport device of FIG. 1A, in accordance with an embodiment of the present disclosure.

FIG. 1C illustrates a front view of the exemplary transport device of FIG. 1A, in accordance with an embodiment of the present disclosure.

FIG. 2A illustrates a perspective view of an exemplary transport device, in accordance with an embodiment of the present disclosure.

FIG. 2B illustrates a side view of the exemplary transport device of FIG. 2A, in accordance with an embodiment of the present disclosure.

FIG. 2C illustrates a front view of the exemplary transport device of FIG. 2A, in accordance with an embodiment of the present disclosure.

FIG. 3A illustrates a perspective view of an exemplary transport device, in accordance with an embodiment of the present disclosure.

FIG. 3B illustrates a side view of the exemplary transport device of FIG. 3A, in accordance with an embodiment of the present disclosure.

FIG. 3C illustrates a front view of the exemplary transport device of FIG. 3A, in accordance with an embodiment of the present disclosure.

FIG. 4 illustrates a perspective view of a chassis of the transport device, in accordance with an embodiment of the present disclosure.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for conducting the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusion, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

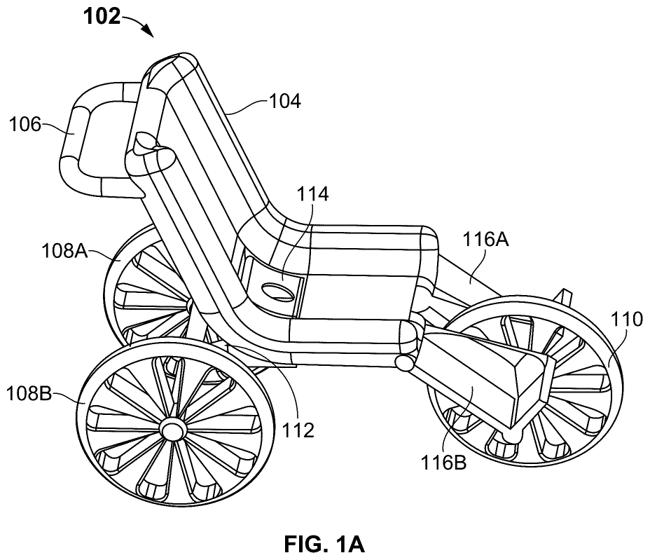

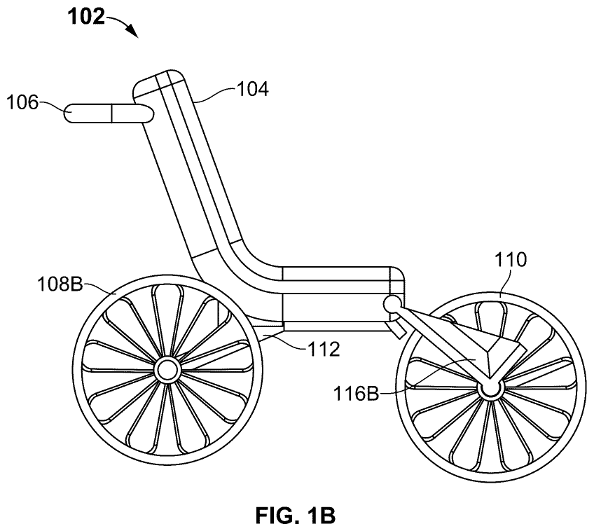

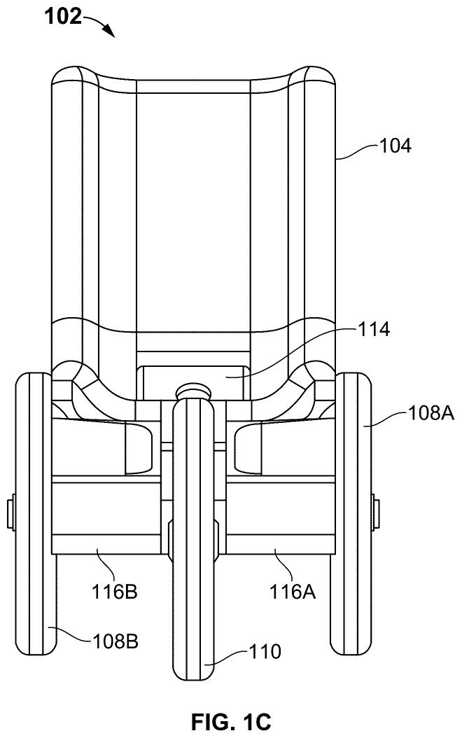

Reference will now be made to the exemplary embodiments of the disclosure, as illustrated in the accompanying drawings. Wherever possible, same numerals have been used to refer to the same or like parts. The following paragraphs describe the present disclosure with reference to FIG. 1A-FIG. 3C. As summarized above, in one broad aspect, the present invention provides a liquid filter for use in a cap of liquid containers.

Referring now to FIG. 1A, a perspective view of an exemplary transport device 102, is illustrated, in accordance with an embodiment of the present disclosure. The transport device 102 is specifically designed to enable safe and efficient transport of patients over uneven and challenging terrains. The various components and features of the transport device 102 are configured to enhance its functionality, stability, and adaptability in such scenarios. The transport device 102 may include a frame assembly 104, a rear handle 106, a rear left wheel 108A, a rear right wheel 108B, a front wheel 110, a shock absorption assembly 112, a bucket seat 114, a left leg cradle 116A, and a right leg cradle 116B.

The rear handle 106 may be coupled to a rear of the frame assembly 104 for manually pushing or pulling the transport device 102. In an embodiment, the rear handle 106 may be detachable and foldable to allow compact storage of the transport device 102. The rear left wheel 108A and the rear right wheel 108B may be rotatably mounted on a rear axle (not shown in figure) connected to the frame assembly 104. The rear left wheel 108A and the rear right wheel 108B may be configured to provide stability and enable movement of the transport device 102 over uneven terrain. The front wheel 110 may be rotatably mounted on a front axle (not shown in figure) connected to the frame assembly. The front wheel 110 may provide directional control and may facilitate traversal over steep and rough terrain. The shock absorption assembly 112 may be coupled to the frame assembly 104 and may be operatively associated with at least the rear left wheel 108A, the rear right wheel 108B, and the front wheel 110. The shock absorption assembly 112 may be configured to reduce impact forces encountered on the rough terrain.

The bucket seat 114 may be mounted to the frame assembly 104 and may be configured to securely hold a user in a seated position. The transport device 102 may further include a removable toilet system (not shown in figure). The removable toilet system may be mounted beneath the bucket seat and may be configured to facilitate sanitary use by the user during transport. The left leg cradle 116A, and the right leg cradle 116B may be coupled to the frame assembly and may be configured to hold legs of the user in place and prevent interference with the front wheel 110 and the rear left wheel 108A, the rear right wheel 108B.

In one exemplary scenario, the transport device 102 may be used to transport a patient over rocky terrain in a mountainous region. The shock absorption assembly 112 minimizes the impact on the patient, while the rear left wheel 108A, the rear right wheel 108B and the front wheel 110 enable efficient navigation of the uneven terrain. The detachable rear handle 106 allows compact storage when the transport device 102 is carried to remote locations.

In another embodiment, the transport device 102 may be equipped with the removable toilet system to cater to patients requiring long-duration transport. This feature proves especially useful in outdoor rescue missions or field hospital operations, where conventional facilities may be unavailable.

Furthermore, the left leg cradle 116A, and the right leg cradle 116B ensure that the patient's legs are securely held in place during transport on steep inclines or declines, preventing accidental entanglements with the wheels. This safety feature, coupled with the overall sturdy design of the frame assembly 104, makes the transport device 102 suitable for both emergency rescue operations and everyday use in care facilities.

Referring now to FIG. 1B, a side view of the exemplary transport device 102 of FIG. 1A, is illustrated, in accordance with an embodiment of the present disclosure. The side view provides a representation of the relative positioning and coupling of the various components of the transport device 102.

The frame assembly 104 forms the structural backbone of the transport device 102, providing a sturdy base to support all other components. The frame assembly 104 is designed to maintain the overall stability and balance of the device while navigating challenging terrains. The rear handle 106, positioned at the rear end of the frame assembly 104, is ergonomically configured for manual pushing or pulling of the transport device 102. In this embodiment, the rear handle 106 is detachable and foldable, allowing the device to be compactly stored or transported when not in use. This configuration enhances portability and convenience.

The rear left wheel 108A and rear right wheel 108B, shown inside profile, are rotatably mounted on a rear axle (not shown in figure) that is integrated with the frame assembly 104. These wheels are designed to provide stability and traction, ensuring smooth operation over uneven and rough terrain. The rear left wheel 108A and rear right wheel 108B positioning relative to the frame assembly 104 ensures proper weight distribution for optimal performance. The front wheel 110, visible from the side view, is rotatably mounted on a front axle (not shown in figure) connected to the frame assembly 104. The front wheel 110 provides directional control and facilitates smooth traversal over steep inclines and obstacles.

The shock absorption assembly 112, shown coupled to the frame assembly 104, is operatively associated with the rear left wheel 108A and the rear right wheel 108B and the front wheel 110. This assembly is configured to absorb and reduce impact forces encountered on uneven and rugged terrains. By mitigating shocks and vibrations, the shock absorption assembly 112 enhances the comfort of the patient seated in the transport device 102 and ensures a smoother ride.

The bucket seat 114 is securely mounted to the frame assembly 104 and is configured to hold the patient in a seated position during transport. The bucket seat 114 provides ergonomic support and stability for the patient, ensuring their safety and comfort throughout the journey. Beneath the bucket seat 114, a provision for an optional removable toilet system (not shown in figure) is included, which facilitates sanitary use by the patient when necessary. The left leg cradle 116A and the right leg cradle 116B, visible from the side view, are securely attached to the frame assembly 104. The left leg cradle 116A and the right leg cradle 116B are configured to hold the patient's legs in place, preventing any interference with the rear left wheel 108A and rear right wheel 108B and the front wheel 110 during movement. This ensures both safety and comfort, particularly on rough terrains.

Referring now to FIG. 1C, a front view of the exemplary transport device 102 FIG. 1A, is illustrated, in accordance with an embodiment of the present disclosure. The frame assembly 104 serves as the structural foundation of the transport device 102, ensuring durability and robustness. In this front view, the frame assembly 104 supports the arrangement of all other components, maintaining the integrity and functionality of the transport device 102 during operation. The bucket seat 114 is centrally mounted to the frame assembly 104. The bucket seat 114 is ergonomically designed to securely hold the patient in a seated position, ensuring comfort and safety during transportation. Its high sides and contoured design provide additional lateral support, reducing the risk of shifting or instability while the transport device 102 is in motion.

The rear left wheel 108A and rear right wheel 108B are positioned symmetrically on either side of the frame assembly 104, providing stability and balance to the device. The width between these wheels ensures that the transport device 102 can maintain equilibrium, even on uneven terrains. These rear left wheel 108A and rear right wheel 108B are designed for smooth rotation and enhanced traction, enabling the transport device 102 to navigate challenging surfaces effectively. The front wheel 110, visible at the centre of the front view, is positioned beneath the bucket seat 114. The rear left wheel 108A and rear right wheel 108B provides directional control, allowing the transport device 102 to manoeuvre through tight spaces and navigate steep or rough terrains with ease. Its central placement enhances the turning radius and overall steering efficiency of the transport device 102.

The left leg cradle 116A and the right leg cradle 116B are mounted on the frame assembly 104 beneath the bucket seat 114. These left leg cradle 116A and the right leg cradle 116B are configured to securely hold the patient's legs in place, preventing movement or interference with the rear left wheel 108A, rear right wheel 108B, and the front wheel 110 during operation. Their ergonomic design ensures patient comfort while maintaining the functionality and safety of the transport device 102. This front view further demonstrates the balance and compactness of the transport device 102, emphasizing its capability to transport patients securely and comfortably across various terrains. The synergy between its components, as shown in FIG. 1C, reflects an optimized design for patient safety, stability, and ease of use.

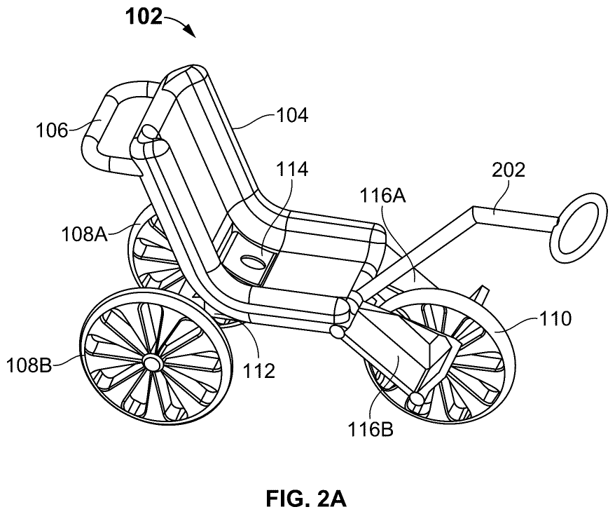

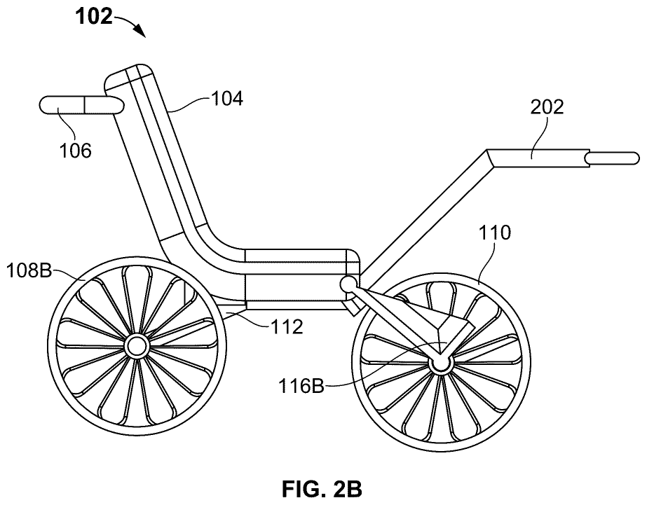

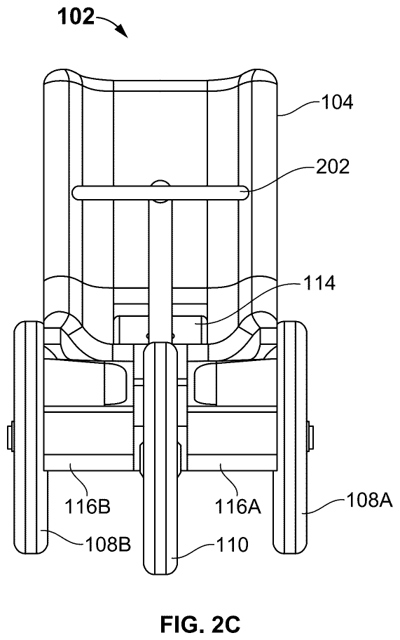

Referring now to FIG. 2A, a perspective view of an exemplary transport device 102, is illustrated, in accordance with an embodiment of the present disclosure. The transport device 102 may include a frame assembly 104, a rear handle 106, a rear left wheel 108A, a rear right wheel 108B, a front wheel 110, a shock absorption assembly 112, a bucket seat 114, a left leg cradle 116A, a right leg cradle 116B, and a front handle 202.

The rear handle 106 may be coupled to a rear of the frame assembly 104 for manually pushing or pulling the transport device 102. In an embodiment, the rear handle 106 may be detachable and foldable to allow compact storage of the transport device 102. The rear left wheel 108A and the rear right wheel 108B may be rotatably mounted on a rear axle (not shown in figure) connected to the frame assembly 104. The rear left wheel 108A and the rear right wheel 108B may be configured to provide stability and enable movement of the transport device 102 over uneven terrain. The front wheel 110 may be rotatably mounted on a front axle (not shown in figure) connected to the frame assembly. The front wheel 110 may provide directional control and may facilitate traversal over steep and rough terrain. The shock absorption assembly 112 may be coupled to the frame assembly 104 and may be operatively associated with at least the rear left wheel 108A, the rear right wheel 108B, and the front wheel 110. The shock absorption assembly 112 may be configured to reduce impact forces encountered on the rough terrain.

The bucket seat 114 may be mounted to the frame assembly 104 and may be configured to securely hold a user in a seated position. The transport device 102 may further include a removable toilet system (not shown in figure). The removable toilet system may be mounted beneath the bucket seat and may be configured to facilitate sanitary use by the user during transport. The left leg cradle 116A, and the right leg cradle 116B may be coupled to the frame assembly and may be configured to hold legs of the user in place and prevent interference with the front wheel 110 and the rear left wheel 108A, the rear right wheel 108B.

The front handle 202 may be coupled to a front of the frame assembly 104 and may be configured to enable pulling of the transport device 102 over steep inclines or rough terrain. The front handle 202 may be detachable and foldable to allow compact storage of the transport device 102.

In one exemplary scenario, the transport device 102 is used to evacuate an injured patient from a remote mountain trail. The operator utilizes the front handle 202 to pull the transport device 102 up steep inclines, while the shock absorption assembly 112 minimizes impact from uneven rocks and gravel, ensuring the patient comfort and safety during the evacuation. The rear handle 106 and left leg cradle 116A, and the right leg cradle 116B further stabilize the transport device 102, preventing accidental tilting or leg movement during transport.

In another embodiment, the transport device 102 is equipped with the removable toilet system beneath the bucket seat 114. This feature allows for extended use during long-distance patient transport in rural or disaster-stricken areas where restroom facilities are unavailable. The combination of the bucket seat 114, the shock absorption assembly 112, and leg cradles 116A, 116B ensures a secure and comfortable journey for the patient. In a field hospital or mobile healthcare unit, the transport device 102 is employed to move patients across uneven terrain, such as gravel roads or grass fields. The front handle 202 and the front wheel 110 enable easy navigation through narrow or irregular pathways, while the foldable rear handle 106 ensures that the transport device 102 can be stored compactly when not in use.

Referring now to FIG. 2B, a side view of the exemplary transport device 102 of FIG. 2A, is illustrated, in accordance with an embodiment of the present disclosure. The transport device 102 is designed for safe and efficient patient transport, particularly over uneven and rough terrains, ensuring stability, comfort, and adaptability.

The frame assembly 104 serves as the main structure of the transport device 102. The frame assembly 104 provides strong support for all the attached components, including the wheels, seat, and handles, while ensuring durability and stability during use. The rear handle 106 is attached to the back of the frame assembly 104. It is used by an operator to manually push or pull the transport device 102. The handle is designed to be foldable and detachable, making it convenient for storage and transport when the device is not in use.

The transport device 102 includes the rear left wheel 108A and the rear right wheel 108B. These wheels are mounted on a rear axle (not visible in this figure) connected to the frame assembly 104. They provide stability and smooth movement, even on rough or uneven surfaces. The front wheel 110, located near the base of the frame assembly 104, allows the transport device 102 to be steered and maneuverer easily. It ensures proper balance and control while navigating tight spaces, steep slopes, or uneven terrains. The shock absorption assembly 112 is integrated with the frame assembly 104 and works with the wheels (108A, 108B, and 110). It reduces the impact of bumps or uneven surfaces, providing a smoother ride and ensuring comfort for the patient seated in the transport device 102.

The bucket seat 114 is securely mounted on the frame assembly 104. It is designed to comfortably hold the patient in place during transport. The bucket seat 114 design provides support and safety, ensuring the patient remains stable. Additionally, the seat can be equipped with a removable toilet system (not shown in this figure), offering convenience during transport.

The transport device 102 includes the left leg cradle 116A and the right leg cradle 116B, which are positioned beneath the bucket seat 114. The left leg cradle 116A and the right leg cradle 116B securely hold the patient's legs, preventing them from moving or interfering with the operation of the front wheel 110 or rear wheels (108A, 108B). The front handle 202 is attached to the front of the frame assembly 104. This handle allows the operator to pull the transport device 102, especially useful when navigating steep inclines or difficult terrain. Like the rear handle 106, it is foldable and detachable for easy storage and portability.

The transport device 102 works seamlessly to provide a smooth and safe transport experience. The rear wheels (108A, 108B) ensure stability, while the front wheel 110 offers steering and directional control. The shock absorption assembly 112 minimizes vibrations and shocks, making the ride comfortable for the patient. The bucket seat 114 and leg cradles (116A, 116B) securely position the patient, preventing unnecessary movements or discomfort. The rear handle 106 and front handle 202 allow the operator to push or pull the device 102 with ease. In one embodiment, if a rough terrain is being traversed, the front handle 209 may be used in concert with the rear handle 106 to balance the chair on rear wheels 108A and 108B in order to traverse large rocks, boulders, steep trails, creeks and other obstacles that would require the transport device have more clearance from the ground.

Referring now to FIG. 2C, a front view of the exemplary transport device 102 of FIG. 2A, is illustrated, in accordance with an embodiment of the present disclosure. The frame assembly 104 forms the main structure of the transport device 102. The frame assembly 104 supports all the other components, ensuring strength and durability. The frame assembly 104 is designed to evenly distribute weight and maintain balance during operation. The transport device 102 includes the rear left wheel 108A and the rear right wheel 108B, positioned on either side of the frame assembly 104. The rear left wheel 108A and the rear right wheel 108B are designed to provide stability and enable the transport device 102 to move smoothly over uneven or rough terrain.

At the centre of the transport device 102 is the front wheel 110, which is smaller than the rear left wheel 108A and the rear right wheel 108B. It plays a critical role in steering and directional control. The front wheel 110 allows the transport device 102 to manoeuvre easily, even in narrow spaces or over challenging surfaces. The bucket seat 114 is securely mounted to the frame assembly 104. It is designed to provide a safe and comfortable seating area for the user. The high sides of the seat help keep the user securely in place, preventing accidental movements or falls.

The transport device 102 includes the left leg cradle 116A and the right leg cradle 116B, positioned below the bucket seat 114. These left leg cradle 116A and the right leg cradle 116B hold the user's legs securely, ensuring they do not touch the wheels or the ground during transport. This feature enhances safety and comfort. The front handle 202 is attached to the front of the frame assembly 104 (not fully visible in this view). It is used for pulling the transport device 102, especially over steep inclines or rough terrain. The front handle 202 can be detached and folded for easy storage.

This front view of the transport device 102 demonstrates how its components work together to ensure stability and comfort. The rear left wheel 108A and the rear right wheel 108B provide a strong base, while the front wheel 110 ensures smooth steering. The bucket seat 114, the left leg cradle 116A and the right leg cradle 116B keep the user securely in place, preventing movement or injury. Together, these features make the transport device 102 safe, reliable, and easy to operate, even on challenging terrain.

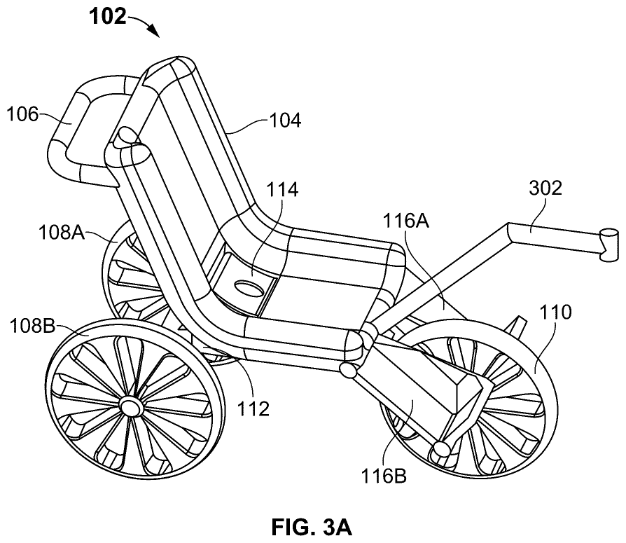

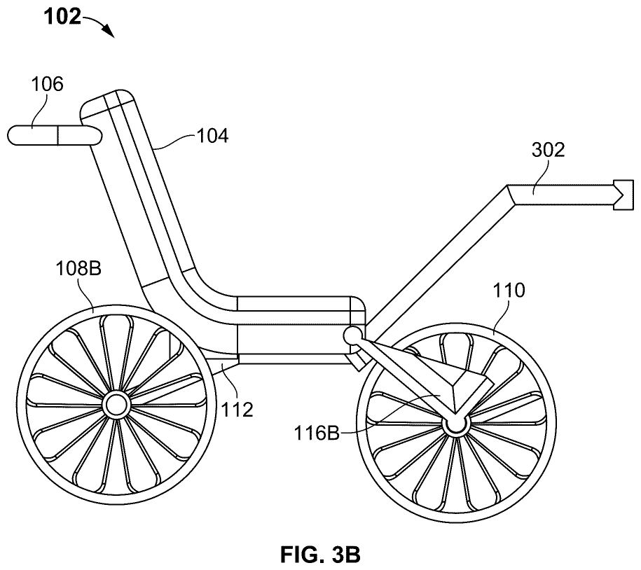

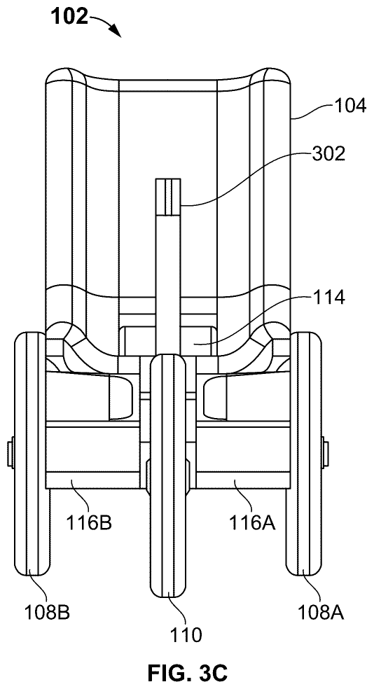

Referring now to FIG. 3A, a perspective view of an exemplary transport device 102, is illustrated, in accordance with an embodiment of the present disclosure. The transport device 102 may include a frame assembly 104, a rear handle 106, a rear left wheel 108A, a rear right wheel 108B, a front wheel 110, a shock absorption assembly 112, a bucket seat 114, a left leg cradle 116A, a right leg cradle 116B, and a front hitch 302.

The rear handle 106 may be coupled to a rear of the frame assembly 104 for manually pushing or pulling the transport device 102. In an embodiment, the rear handle 106 may be detachable and foldable to allow compact storage of the transport device 102. The rear left wheel 108A and the rear right wheel 108B may be rotatably mounted on a rear axle (not shown in figure) connected to the frame assembly 104. The rear left wheel 108A and the rear right wheel 108B may be configured to provide stability and enable movement of the transport device 102 over uneven terrain. The front wheel 110 may be rotatably mounted on a front axle (not shown in figure) connected to the frame assembly. The front wheel 110 may provide directional control and may facilitate traversal over steep and rough terrain. The shock absorption assembly 112 may be coupled to the frame assembly 104 and may be operatively associated with at least the rear left wheel 108A, the rear right wheel 108B, and the front wheel 110. The shock absorption assembly 112 may be configured to reduce impact forces encountered on the rough terrain.

The bucket seat 114 may be mounted to the frame assembly 104 and may be configured to securely hold a user in a seated position. The transport device 102 may further include a removable toilet system (not shown in figure). The removable toilet system may be mounted beneath the bucket seat and may be configured to facilitate sanitary use by the user during transport. The left leg cradle 116A, and the right leg cradle 116B may be coupled to the frame assembly and may be configured to hold legs of the user in place and prevent interference with the front wheel 110 and the rear left wheel 108A, the rear right wheel 108B.

The front hitch 302 may be coupled to the frame assembly 104 and may be configured for attachment to a bicycle (not shown in figure), thereby enabling the transport device 102 to be towed over varied terrains. The front hitch 302 may be detachable and foldable to facilitate easy attachment and detachment from the bicycle.

In one exemplary scenario, the transport device 102 is used to evacuate an injured patient from a remote forest trail. The front hitch 302 allows the transport device 102 to be securely attached to a bicycle, enabling rapid and efficient towing to a nearby medical facility. The shock absorption assembly 112 ensures that the patient remains comfortable during transit over rough terrain, while the pair of leg cradles 116A, 116B prevent accidental leg movement or injury.

In another embodiment, the transport device 102 is employed for outdoor recreational activities, such as enabling a person with limited mobility to participate in cycling excursions. The front hitch 302 allows seamless towing by a bicycle, while the bucket seat 114 and the pair of leg cradles 116A, 116B provide stability and security for the patient throughout the journey. The foldable rear handle 106 ensures compact storage of the transport device 102 after use. During a rescue operation in a mountainous region, the transport device 102 can be used to safely transport an injured individual. The front hitch 302 enables attachment to a rescue bicycle, allowing swift movement through rough terrain where motorized vehicles cannot operate. The pair of rear wheels 108A, 108B, the shock absorption assembly 112, and the bucket seat 114 of the transport device 102 ensure the safety and comfort of the patient during the rescue.

Referring now to FIG. 3B, a side view of the exemplary transport device 102 of FIG. 3A, is illustrated, in accordance with an embodiment of the present disclosure. The frame assembly 104 forms the main structure of the transport device 102. It is sturdy yet lightweight, supporting all other parts while ensuring durability. This design allows the device to be used reliably across different terrains. The rear handle 106 is located at the back of the frame. It is used to push or pull the transport device manually. To make the transport device 102 easy to store, the handle can be folded or detached when not in use. The rear left wheel 108A and the rear right wheel 108B are mounted at the back of the transport device. The rear left wheel 108A and the rear right wheel 108B are built to ensure stability and smooth movement over uneven ground. They are attached to the frame assembly 104 via a rear axle (not visible in this side view), allowing free rotation for efficient mobility.

The front wheel 110 is smaller than the rear wheels and is located at the front of the frame. This wheel helps with steering and provides directional control. It is designed to handle steep and rough terrain, making the transport device 102 easier to movement. The shock absorption assembly 112 is connected to the frame and works with the wheels to reduce bumps and impacts caused by rough surfaces. This feature ensures a smoother ride and greater comfort for the user, even on uneven ground. The bucket seat 114 is securely attached to the centre of the frame assembly 104. It is designed to hold the user in a stable and comfortable sitting position. This feature ensures safety during transport, as the user remains securely seated even on bumpy terrain.

The left leg cradle 116A and right leg cradle 116B are positioned beneath the bucket seat. These cradles keep the user's legs in place, preventing them from touching the wheels or the ground. This improves safety and makes the device more comfortable for the user. The front hitch 302 is located at the front of the frame. This front hitch 302 allows the transport device to be connected to a bicycle for towing. It is designed to be foldable and detachable, making it easy to attach or remove when needed. This feature makes the device versatile for both manual use and towing.

Referring now to FIG. 3C, a front view of the exemplary transport device of FIG. 3A, is illustrated, in accordance with an embodiment of the present disclosure. The frame assembly 104 is the central structure of the transport device, holding all the other components together. It provides the support needed for the device to be durable and strong enough to handle rough terrain. The frame's design ensures that the device is stable, even when navigating challenging surfaces. The rear handle 106 is located at the back of the frame, allowing the transport device to be manually pushed or pulled. The rear handle 106 is ergonomically designed for comfortable grip and use. In some embodiments, the rear handle 106 can be detached or folded to allow for more compact storage, making it convenient for transport when not in use.

The rear left wheel 108A and the rear right wheel 108B are positioned at the back of the device. These wheels are larger than the front wheel, providing stability for the transport device, especially on uneven surfaces. These wheels are mounted on a rear axle (not visible), which allows them to rotate freely. Their design ensures that the device maintains balance and can move smoothly over a variety of terrains, including rough or bumpy ground.

The shock absorption assembly 112 is integrated into the frame and connected to all three wheels (rear left wheel, rear right wheel, and front wheel). Its main function is to absorb the shock and impact caused by rough surfaces. When the transport device moves over bumpy or uneven ground, the shock absorbers reduce the jarring effects on both the user and the device, providing a smoother, more comfortable experience.

The bucket seat 114 is securely mounted to the frame assembly, ensuring that the user is comfortably and safely seated during transport. The bucket seat 114 is designed to hold the user in place while maintaining a stable position. This is especially important when traveling on rough or bumpy terrain, as the seat helps prevent unnecessary movement that could affect the user's safety or comfort. The left leg cradle 116A and right leg cradle 116B are designed to securely hold the user's legs in place. Positioned beneath the bucket seat, these cradles prevent the legs from interfering with the movement of the wheels, ensuring that the user remains comfortable and stable throughout the ride. These cradles also help prevent the legs from coming into contact with the wheels, which could otherwise cause discomfort or even injury.

The front hitch 302 is located at the front of the frame assembly and is designed for attachment to a bicycle (not shown in the figure). This feature enables the transport device 102 to be towed over various terrains, allowing the user to travel longer distances without physically pushing or pulling the transport device 102. The front hitch 302 is detachable and foldable, making it easy to attach and remove from the bicycle. This functionality adds versatility to the transport device 102, as it can be used both manually and in conjunction with a bicycle for towing.

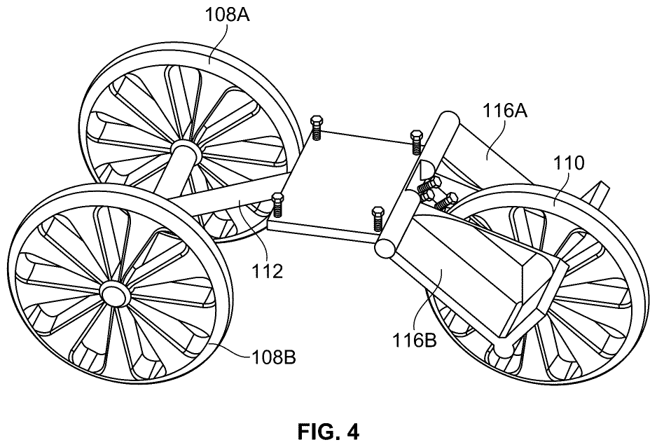

Referring now to FIG. 4, a perspective view of a chassis of the transport device 102, in accordance with an embodiment of the present disclosure. The chassis forms the core structure of the device, providing support for various components. The transport device 102 may include the chassis which may include the shock absorption assembly 112, the pair of rear wheels 108A and 108B, the front wheel 110, and the pair of leg cradles 116A and 116B. The shock absorption assembly 112 is operatively associated with the chassis and provides essential damping during the movement of the transport device 102 over rough surfaces. Mounted to the rear of the chassis are the pair of rear wheels 108A and 108B, which are attached via a rear axle (not specifically numbered). At the front of the chassis, the front wheel 110 is attached to a front axle (not specifically numbered), which is also connected to the chassis. Additionally, the chassis incorporates the pair of leg cradles 116A and 116B, which are mounted to the chassis and extend outward to securely hold the patient legs in place.

Thus, the disclosed transport device 102 tries to overcome the technical problem of safely and efficiently transporting patients over uneven, rough, or steep terrains while ensuring comfort, stability, and ease of operation. Traditional patient transport devices often fail to address the challenges posed by rugged terrains, limited portability, and inadequate shock absorption, which can result in discomfort or even injury to the patient during transit. Additionally, existing solutions lack versatility in adapting to various use cases, such as manual operation or towing by a bicycle, limiting their applicability in diverse scenarios, such as remote rescue operations, recreational use, or emergency evacuations.

The transport device 102 addresses these issues through its innovative design, which incorporates features such as the frame assembly 104, the shock absorption assembly 112 to minimize impact forces, ergonomic components like the bucket seat 114 and the pair of leg cradles 116A, 116B for patient safety and comfort, and versatile operational elements such as the rear handle 106, the detachable front handle 202, and the detachable front hitch 302. These components work in synergy to provide a reliable and adaptable solution for patient transport, catering to both manual and bicycle-towed operations, and ensuring functionality across various terrains and environments.

The disclosed transport device 102 offers several advantages over traditional patient transport systems. The inclusion of the frame assembly 104 ensures durability and structural stability, enabling the device to handle uneven and rugged terrains effectively. The rear handle 106, which is detachable and foldable, facilitates ease of operation during manual pushing or pulling and allows for compact storage when not in use. The combination of the rear left wheel 108A, the rear right wheel 108B, and the front wheel 110, mounted on respective axles, provides excellent stability and directional control, making it suitable for traversing steep inclines and rough terrain.

The shock absorption assembly 112 significantly enhances patient comfort by reducing the impact forces encountered during transport, ensuring a smoother ride even on harsh surfaces. The bucket seat 114, designed to securely hold the patient in a seated position, along with the left leg cradle 116A and the right leg cradle 116B, ensures that the patient's legs are safely restrained, preventing interference with the wheels during movement. Additionally, the inclusion of the front handle 202 or the front hitch 302 offers operational versatility by allowing the device to be manually pulled or towed by a bicycle, depending on the situation, thereby expanding its applicability to diverse scenarios such as rescue operations, outdoor activities, or emergency evacuations.

Furthermore, the optional removable toilet system (not shown in the figures) mounted beneath the bucket seat 114 adds a layer of convenience by facilitating sanitary use during transport. The foldable and detachable features of the device's key components, such as the rear handle 106, the front handle 202, and the front hitch 302, make it compact and portable, addressing storage and transportation challenges. Together, these features make the transport device 102 a highly functional, adaptable, and user-friendly solution for patient transport over varied terrains.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

The foregoing description and accompanying figures illustrate the principles, embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

1. A transport device, comprising:
a frame assembly;
a bucket seat having a backrest portion and a seat portion, mounted to the frame assembly, configured to securely hold a user in a seated position;
a rear handle coupled to the frame assembly behind the backrest of the bucket seat, for manually pushing or pulling the device;
a pair of rear wheels having a common diameter, one each rotatably mounted on a rear axle connected to the frame assembly, wherein the bucket seat is positioned between the pair of rear wheels and the pair of rear wheels are configured to provide stability and enable movement of the device over uneven terrain;
a single front wheel having the common diameter, rotatably mounted on a front axle extending orthogonally from the frame assembly and centred beneath the seat portion of the bucket seat, wherein the front wheel provides directional control and facilitates traversal over steep and rough terrain;
a first leg cradle and a second leg cradle, coupled to the frame assembly, each configured to partially surround and support a lower leg of a user in in a stationary position, one each of the first and second leg cradles positioned adjacent to opposing lateral sides of the single front wheel with the front wheel positioned directly between the first and second leg cradles and prevents interference with the front wheel during transport.

2. The device of claim 1, wherein the rear handle is detachable and foldable to allow compact storage of the device.

3. The device of claim 1, further comprising a removable toilet system, mounted beneath the bucket seat, configured to facilitate sanitary use by the user during transport.

4. A transport device, comprising:
a frame assembly;
a bucket seat having a backrest portion and a seat portion, mounted to the frame assembly, configured to securely hold a user in a seated position;
a rear handle coupled to a rear of the frame assembly behind the backrest of the bucket seat, for manually pushing or pulling the device;
a pair of rear wheels having a first diameter, one each rotatably mounted on a rear axle connected to the frame assembly, wherein the bucket seat is positioned between the pair of rear wheels and the pair of rear wheels are configured to provide stability and enable movement of the device over uneven terrain;
a single front wheel having the first diameter, rotatably mounted on a front axle extending orthogonally from the frame assembly and centred beneath the seat portion of the bucket seat, wherein the front wheel provides directional control and facilitates traversal over steep and rough terrain;
a shock absorption assembly, coupled to the frame assembly and operatively associated with at least the pair of rear wheels and the front wheel, configured to reduce impact forces encountered on the rough terrain;
a pair of leg cradles, coupled to the frame assembly, each configured to partially surround and support a lower leg and feet of a user in place, one each on opposing sides of the single front wheel and prevent interference with the front wheel and the pair of rear wheels during transport; and
a front handle, coupled to a front of the frame assembly centred over and extending further than the first diameter of the single front wheel and configured to enable pulling of the device over steep inclines or rough terrain while the user is in the bucket seat.

5. The device of claim 4, wherein the front handle is detachable and foldable to allow compact storage of the device.

6. The device of claim 4, further comprising a removable toilet system, mounted beneath the bucket seat, configured to facilitate sanitary use by the user during transport.

7. The device of claim 4, wherein the rear handle is detachable and foldable to allow compact storage of the device.

8. A transport device, comprising:
a frame assembly;
a bucket seat having a backrest portion and a seat portion, mounted to the frame assembly, configured to securely hold a user in a seated position;
a rear handle coupled to a rear of the frame assembly, for manually pushing or pulling the device;
a pair of rear wheels having a first diameter, on each rotatably mounted on a rear axle connected to the frame assembly, wherein the pair of rear wheels are configured to provide stability and enable movement of the device over uneven terrain;
a single front wheel having the first diameter, rotatably mounted on a front axle connected to the frame assembly, wherein the front wheel enabling directional control and facilitates traversal over steep and rough terrain;
a shock absorption assembly, coupled to the frame assembly and operatively associated with at least the pair of rear wheels and the front wheel, configured to reduce impact forces encountered on the rough terrain;
a pair of leg cradles, coupled to the frame assembly, configured to partially surround and support a lower leg of a user in place, one each positioned on opposing lateral sides of the front wheel and prevent interference with the front wheel and the pair of rear wheels during transport; and
a front hitch, coupled to the frame assembly centered over the single front wheel and extending further than the first diameter of the single front wheel and configured for attachment to a second transport vehicle, enabling the device to be towed over varied terrains.

9. The device of claim 8, wherein the front hitch is detachable and foldable to facilitate easy attachment and detachment from the bicycle.

10. The device of claim 8, further comprising a removable toilet system, mounted beneath the bucket seat, configured to facilitate sanitary use by the user during transport.

11. The device of claim 8, wherein the rear handle is detachable and foldable to allow compact storage of the device.
